(19) United States
(12) Patent Application Publication
(10) Pub. No.: US 2013/0046681 A1
(43) Pub. Date: Feb. 21, 2013

(54) METHOD OF IMPROVING HIGHWAY SAFETY BY DETERRING SPEEDING

(71) Applicant: JEFF LLOYD, Gainesville, FL (US)

(72) Inventor: JEFF LLOYD, Gainesville, FL (US)

(73) Assignee: Jeff Lloyd, Gainesville, FL (US)

(21) Appl. No.: 13/243,316

(22) Filed: Sep. 23, 2011

Related U.S. Application Data
(60) Provisional application No. 61/525,497, filed on Aug. 19, 2011.

(51) Int. Cl. G06F 7/00; G06Q 40/00; G01M 17/00

(52) U.S. Cl. 705/39; 701/36

(57) ABSTRACT

Method and means of deterring speeding are disclosed. A plurality of detection devices positioned along a road detect a transmission device mounted in a vehicle as it passes in proximity to the detection devices. Each transmission device is identifiable to a registered user via an identifier unique to the transmission device. When a vehicle carrying a transmission device passes a detection device, the unique identifier and the time of the vehicle's passing are stored. Known distances between the plurality of detection devices enable calculation of average speed of the vehicle using the time stamps of the vehicle's passing between any two detection devices. If the vehicle's average speed exceeds an acceptable speed for that portion of road, the registered user is notified, thereby deterring future speeding. A fine can be deducted from an account associated with the registered user or the registered user's transmission device.

### CROSS-REFERENCE TO RELATED APPLICATION

This application claims the benefit of U.S. Provisional Application Ser. No. 61/525,497, filed Aug. 19, 2011, which is hereby incorporated by reference in its entirety.

### BACKGROUND

As anyone who has driven on the highway knows, in the absence of a visible law enforcement presence, many drivers tend to speed, some quite significantly above posted speed limits. Often, those drivers traveling far in excess of posted speed limits cause situations which threaten the safety of themselves and other drivers on the highway. Accordingly, further means of deterring drivers from speeding are desired.

### BRIEF SUMMARY

The present invention is a method of deterring speeding by having a plurality of detection devices mounted at various points along the road that detect transmission devices mounted in vehicles as the vehicles pass in proximity to the detection devices. Each transmission device is uniquely identifiable to a registered user/driver. The transmission device can be provided with the vehicle, installed by the vehicle's manufacturer or retailer, or it can be an after-market device acquired by the user independent of the vehicle.

As the transmission device passes in close proximity to a detection device, the detection device receives information from the transmission device which is stored in a database along with the time of the vehicle's passing. This information can include a unique identifier of the transmission device, which is identifiable to a registered user/driver. As the vehicle comes into close proximity of the next detection device on the road, the detection device receives the information from the transmission device and the time of the vehicle's passing is stored.

With any two detection devices, by storing the vehicle's time of passing and associated identifying information from the transmission device, the time that it took the vehicle to get from the first detection device to the second detection device can be calculated.

The detection devices can be configured to store the transmission device identifier and time of detection and transmit the stored data to a processing device for performing the calculations. The processing device can be located at a remote location, such as a base station, central server, or cloud. In addition, a copy of the stored information from each detection device can be stored and provided at the remote location, enabling periodic purging or overwriting of a memory of the detection device.

The distances between the plurality of detection devices on the road are known. The average speed of the vehicle from the first detection device to the second detection device can be calculated using the time stamps of the vehicle's passing.

If the vehicle's average speed exceeds the posted speed limit (or acceptable range of speed) for that section of road, the identifying information received from the vehicle's transmission device provides the identity of the registered user.

The registered user can then be notified that the registered user's vehicle exceeded the lawful speed. In an embodiment, the notification can be mailed to the registered user. In another embodiment, the notification can be by phone call, text message, or other means. In an embodiment, the notification can comprise a fine. In a preferred embodiment, the registered user has an account associated with the transmission device. A fine or excessive speed fee can be deducted from the account, thereby deterring the registered user from allowing the user's vehicle to exceed the posted speed on a road having such detection devices.

### DETAILED DESCRIPTION

In the present invention, a plurality of detection devices is located along a road. The road may be a public road maintained by funds from a local town or city municipality, state government, or federal government. The road may be privately owned by an individual entity. The detection devices may be fixed along structures including, but not limited to a detection device roadway gantry, a stop sign or other road sign, a roadway mile marker, a traffic signal or traffic signal structure, a toll booth, a roadway guardrail, a concrete roadway median or roadway median made of any other material.

The transmission device is mounted to a vehicle or is contained within the vehicle. In an embodiment of the invention, the transmission device is mounted internally in the cabin of the vehicle on the glass surface of the windshield or on the dashboard. The transmission device may be mounted internally in the cabin of the vehicle in a plurality of locations including but not limited to any glass surface, front seats, back seats, center console, dashboard, side door panels, rear view mirror or any other surface in the cabin. In another embodiment of the invention, the transmission device may be integrated with the central computer of the vehicle. In another embodiment, the transmission device may be mounted on the external surface of the vehicle. The transmission device may be mounted on the external body of the vehicle in plain view or mounted on the external body hidden from view. In an embodiment, the transmission device may be built into the structure of the external body in a number of locations including but not limited to the front bumper, rear bumper, front fenders, rear fenders, the hood, the trunk, the roof, the side view mirrors, the side panels, the front driver side door or the front and rear passenger doors. A vehicle includes but is not limited to an automobile, motorcycle, scooter, sports utility vehicle, limousine, truck, semi-trailer truck, recreational vehicle, or any type of vehicle which a user may registered an account and provide the account with funds against which tolls may be electronically deducted.

In a preferred embodiment, the transmission device utilizes radio frequency identification (RFID) to communicate with the detection device. As the vehicle approaches the location of the first detection device, the transmission device transmits information including the unique identifier of the transmission device. The first detection device receives the identifier signal from the transmission device and a time stamp associated with the first detection device is indicated. The time stamp contains information about the date and time the vehicle passed through the location of the detection device. For example, a time stamp may include the day, month, year, hour, minute, second and millisecond of when the vehicle with the transmission device came within close proximity of the detection device. The time stamp is stored on a machine or computer containing a non-transient computer readable storage medium. As the vehicle approaches the location of the second detection device, the transmission device transmits information including the unique identifier of the transmission device. The second detection device receives the identifier signal from the transmission device and a second time stamp is indicated and stored on a machine or computer containing a non-transient computer readable storage medium. The location of the first and second detection devices is stored in the memory of the machine or computer. The distance between the first and second detection devices is retrieved from memory, along with the time stamp associated with the transmission device passing in close proximity of the first detection device and the time stamp associated with the transmission device passing in close proximity of the second detection device. A set of instructions to calculate the average speed of the vehicle is executed by a microprocessor which utilizes the information retrieved from memory including the distance between the first and second detection devices, the time stamp associated with the transmission device passing in close proximity of the first detection device and the time stamp associated with the transmission device passing in close proximity of the second detection device. The average speed of the vehicle from the first detection device to the second detection device is stored in a non-transient computer readable storage device. A predetermined maximum acceptable speed (or a predetermined minimum unacceptable speed) from the first detection device to the second detection device is retrieved from memory. The predetermined speed value is compared to the previously calculated and stored average speed of the vehicle from the first detection device to the second detection device.

When the average speed of the vehicle exceeds the predetermined maximum speed, or is equal to or greater than the predetermined minimum unacceptable speed, an excessive speed fee is assessed and the detection device transmits information related to the identity of the transmitter device. The transmitter device is associated with a registered user account, against which an excessive speed fee is billed. In an embodiment of the invention, the excessive speed fee is assessed and a notification is sent to one or more registered users. In another embodiment of the invention, only a notification is sent to one or more registered users of the transmitter device. In an embodiment of the invention, a registered user may be a parent or guardian of the vehicle driver.

In another embodiment of the invention, when the average speed of the vehicle exceeds the predetermined maximum speed, or meets or exceeds the predetermined minimum unacceptable speed, points are assessed against the registered user of the transmitter device. The number of points assessed can be directly correlated to the amount in excess of the predetermined speed value at which the vehicle was traveling between the first detection device and the second detection device. The greater the average speed of the vehicle between the first detection device and the second detection device in comparison to the predetermined speed value, an increasing number of points can be assessed to the registered user.

For example, a vehicle traveling at an average speed between detection devices of only 2 miles per hour above a minimum unacceptable speed might only be assessed 1 point while a vehicle traveling at an average speed between detection devices of 10 miles per hour above the minimum unacceptable speed might be assessed 3 points. Alternatively, points might be assessed at a 1:1 or 1:2 ratio of points to mph in excess of the predetermine speed value.

In an embodiment of the invention, the points are assessed to a registered user and may be stored for a predetermined period of time. When the registered user accumulates or exceeds a predetermined number of assessed points, a fee is assessed against the registered user's account. The fee may be automatically deducted from the registered user's account. In another embodiment, the registered user is sent a detailed bill through electronic mail or through a letter in the mail. In another embodiment, the assessed fee is accompanied by a notification that is transmitted to the registered user. The notification may be sent by electronic mail, text message, or a letter in the mail. When the predetermined period of time for storing an accumulated number of points elapses, the number of points a registered user may accumulate before being assessed a fee is reset. In another embodiment, the registered user may be sent a notification without being assessed a fee when a registered user accumulates or exceeds a predetermined number of points. The notification can serve as a warning to the registered user to inform the user of an accumulation of points.

In an embodiment of the invention, the predetermined maximum acceptable speed is 10 miles per hour over the posted speed limit between the first detection device and the second detection device. In another embodiment of the invention, the predetermined maximum acceptable speed is 10 percent over the posted speed limit between the first detection device and the second detection device. In another embodiment, the predetermined maximum acceptable speed is 10 kilometers per hour over the posted speed limit between the first detection device and the second detection device.

In another embodiment of the invention, the registered user's account is associated with the department of motor vehicles. When an excessive speed fine or ticket is assessed, the department of motor vehicles is notified of the occurrence. Appropriate actions may be taken to further deter drivers with several excessive speed fines or drivers who have accumulated a predetermined amount of points. Appropriate actions may include suspension or revocation of the registered user's driving privileges.

### Example 1

In the state of Florida, toll roads throughout the state have toll booths equipped with detection devices as a part of the SunPass system. Drivers who wish to pay their tolls electronically rather than waiting in often lengthy lines have the option of buying a SunPass transmission device, each of which has unique identification data associated with that particular device.

A user of the SunPass transmission device then registers his or her personal information to create an account associated with that particular device and provides the account with funds against which tolls may be electronically deducted. The funds may be replenished automatically when the balance exceeds a minimum threshold or at the registered user's discretion. The SunPass transmission device is mounted in the user's vehicle, and as the vehicle is travelling on toll roads in the state of Florida, it passes through a toll plaza. A detection device associated with the toll plaza receives information from the user's SunPass transmission device and the user's SunPass account is deducted an appropriate amount as a toll. In the present invention, the time of the vehicle passing through the toll booth would be stored along with the information from the user's SunPass device. The next time that the user's SunPass transmission device passes a SunPass detection device, the registered user's device is identified and the time stored.

The time difference between passing the first detection device and the second detection device is calculated. The distance between the first and second detection devices is known. The average speed that the SunPass transmission device was traveling between the first and second detection devices is calculated. If this average speed exceeds the posted speed limit (or acceptable value) for that section of road, the registered user for the SunPass transmission device is notified. The notification can be by, for example, any one or a combination of computer generated phone call, letter, email, text message, or other means. The notification can comprise a statement that an excessive speed fee or fine is due. Optionally, the excessive speed fee can be deducted from the registered user's SunPass account.

As an alternative to an RFID-type transmission device such as the exemplified SunPass device, the transmission device can be a GPS compatible device, for example, such as a GARMIN navigation device, or it can be a cell phone. Those of skill in the art in view of this disclosure are readily able to substitute functionally equivalent transmission devices and detection devices compatible therewith to accomplish the purpose of the disclosed method without undue experimentation.

### Example 2

In another embodiment of the present invention, a plurality of detection devices is located on traffic signal structures or any other type of structure at intersections. In previous embodiments, the plurality of detection devices were located at toll booths on highways containing speed limits that are typically 65 miles per hour or higher. In this embodiment, safety is improved by deterring speeding on roads within a municipality, town, or city rather than state and interstate highways, turnpikes, or parkways. These roads typically have a speed limit of 45 miles per hour or less. This speed limit is often exceeded by drivers during off peak traffic hours. The vehicle contains a transmission device which is uniquely identifiable to a registered user or driver. The user registers their personal information to create an account associated with the transmission device. The transmission device is mounted to the vehicle and as the vehicle is travelling on roads, it passes through intersections containing traffic signal structures. A detection device associated with the intersection receives information from the user's transmission device and the time of the vehicle passing through the intersection is stored along with the information from the user's transmission device that identifies the transmission device, the vehicle and the registered user. When the user's transmission device passes through a subsequent intersection with a detection device, the registered user's device is identified and the time is stored again.

The time difference between passing the first detection device and the second detection device is calculated. The distance between the first and second detection devices is known. The average speed that the vehicle with a transmission device was traveling between the first and second detection devices is calculated. If this average speed exceeds the posted speed limit (or acceptable value) for that section of road, the registered user for the transmission device is notified. The notification can be by, for example, any one or a combination of computer generated phone call, letter, email, text message, or other means. The notification can comprise a statement that an excessive speed fee or fine is due. Optionally, the excessive speed fee can be deducted from the registered user's account.

Certain embodiments of the invention contemplate the use of a machine in the form of a computer system within which a set of instructions, when executed, may cause the machine to perform any one or more of the methodologies discussed above. In some embodiments, the machine can operate as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure can include broadly any electronic device that provides voice, video, or data communication. Further, while a single machine is exemplified, the term “machine” shall also be taken to include any collection of machines that individually or jointly execute a set (or multiple sets) of instructions to perform any one or more of the methodologies discussed herein. The computer system can include a processor (e.g., a central processing unit (CPU), a graphics processing unit (GPU), or both), a main memory, and a static memory, which communicate with each other via a bus. The computer system can further include a video display unit (e.g., a liquid crystal display or LCD, a flat panel, a solid state display, or a cathode ray tube or CRT). The computer system can include an input device (e.g., a keyboard or keypad), a cursor control device (e.g., a mouse), a mass storage medium, a signal generation device (e.g., a speaker or remote control) and a network interface device.

The mass storage medium can include a computer-readable storage medium on which is stored one or more sets of instructions (e.g., software) embodying any one or more of the methodologies or functions described herein, including those methods illustrated above. The computer-readable storage medium can be an electromechanical medium such as a common disk drive, or a mass storage medium with no moving parts such as Flash or other non-volatile memories. The instructions can also reside, completely or at least partially, within the main memory, the static memory, and/or within the processor during execution thereof by the computer system. The main memory and the processor also may constitute computer-readable storage media. In an embodiment, non-transitory media are used.

Dedicated hardware implementations including, but not limited to, application specific integrated circuits, programmable logic arrays, and other hardware devices, can be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, certain methods described herein are intended for operation as software programs running on one or more computer processors. Furthermore, software implementations including, but not limited to, distributed processing, component/object distributed processing, parallel processing, and virtual machine processing, can also be constructed to implement the methods described herein.

The present disclosure also contemplates a machine- (or computer-) readable medium containing instructions for executing particular tasks, and which may be a single medium or multiple media (e.g., a centralized or distributed database, and/or associated caches and servers) that stores the instructions. In an embodiment, non-transitory media are used.

Although the present specification describes components and functions implemented in certain embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Aspects of the invention can be described in the general context of computer-executable instructions, such as program modules, being executed by a computer. Generally, program modules include routines, programs, objects, components, data structures, etc., that perform particular tasks or implement particular abstract data types. Such program modules can be implemented with hardware components, software components, or a combination thereof.

Moreover, those skilled in the art will appreciate that the invention can be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Certain embodiments of the invention can be practiced in distributed-computing environments where tasks are performed by remote-processing devices that are linked through a communications network or other communication medium. In a distributed-computing environment, program modules can be located in both local and remote computer-storage media including memory storage devices. The computer-useable instructions form an interface to allow a computer to react according to a source of input. The instructions cooperate with other code segments or modules to initiate a variety of tasks in response to data received in conjunction with the source of the received data.

Certain embodiments of the invention can be practiced in a network environment such as a communications network. Such networks are widely used to connect various types of network elements, such as routers, servers, and gateways. Further, the invention can be practiced in a multi-network environment having various connected public and/or private networks. Communication between network elements can be wireless or wired. As will be appreciated by those skilled in the art, communication networks can take several different forms and can use several different communication protocols.

All patents, patent applications, provisional applications, and publications referred to or cited herein are incorporated by reference in their entirety, including all figures and tables, to the extent they are not inconsistent with the explicit teachings of this specification.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A method of inhibiting speeding, the method comprising:
providing a plurality of electronic detection devices along a road;
detecting, via a first of said electronic detection devices, information from an electronic transmission device in a vehicle when the vehicle passes in proximity to said first detection device, the information comprising a unique identifier of the transmission device;
storing the time of said detecting by said first detection device on a non-transient computer readable storage medium;
detecting, via a second of said electronic detection devices, information from the transmission device when the vehicle passes in proximity to said second detection device, the information comprising the unique identifier of the transmission device;
storing the time of said detecting by said second detection device on a non-transient computer readable storage medium;
calculating via machine the average speed that the vehicle traveled between said first detection device and said second detection device;
comparing via machine said average speed of the vehicle to a predetermined maximum acceptable speed or a predetermined minimum unacceptable speed between said first and second detection devices; and
associating said unique identifier with a registered user and notifying the registered user if said average speed is greater than the predetermined maximum acceptable speed or is equal to or greater than the predetermined minimum unacceptable speed;
wherein said first and second electronic detection devices each receive the identifier signal from the electronic transmission device and indicate a time stamp that is stored on a non-transitory computer readable storage medium.

2. The method of claim 1, further comprising:
assessing an excessive speed fee against the registered user if said average speed is greater than the predetermined maximum acceptable speed or is equal to or greater than the predetermined minimum unacceptable speed.

3. The method of claim 2, wherein the registered user has an account associated with said unique identifier and the excessive speed fee is deducted from the account.

4. The method of claim 1, wherein there is at least one posted speed limit between said first and second detection devices and wherein either the predetermined maximum acceptable speed or the predetermined minimum unacceptable speed is 10 miles per hour above the average speed of travelling at the posted speed limits between said first and second detection devices.

5. The method of claim 1, wherein there is at least one posted speed limit between said first and second detection devices and wherein either the predetermined maximum acceptable speed or the predetermined minimum unacceptable speed is 10% above the average speed of traveling at the posted speed limits between said first and second detection devices.

6. The method of claim 1, wherein there is at least one posted speed limit between said first and second detection devices and wherein either the predetermined maximum acceptable speed or the predetermined minimum unacceptable speed is 10 kilometers per hour above the average speed of travelling at the posted speed limits between said first and second detection devices.

7. The method of claim 2, wherein the assessing is or accompanies the notifying.

8. The method of claim 1, further comprising:
assessing points against the registered user if the average speed is greater than the predetermined maximum acceptable speed or is equal to or greater than the predetermined minimum unacceptable speed.

9. The method of claim 8, wherein the assessing is or accompanies the notifying.

10. The method of claim 8, further comprising:
storing said points for a predetermined period of time; and
assessing a fine against the registered user when the total of accumulated said points exceeds a predetermined number.

11. The method of claim 9, further comprising:
storing said points for a predetermined period of time; and
assessing a fine against the registered user when the total of accumulated said points exceeds a predetermined number.

12. The method of claim 8, wherein as the average speed exceeds the predetermined maximum acceptable speed or minimum unacceptable speed by a greater and greater amount, an increasing number of points are assessed.

13. The method of claim 9, wherein as the average speed exceeds the predetermined maximum acceptable speed or minimum unacceptable speed by a greater and greater amount, an increasing number of points are assessed.

14. The method of claim 10, wherein as the average speed exceeds the predetermined maximum acceptable speed or minimum unacceptable speed by a greater and greater amount, an increasing number of points are assessed.

15. The method of claim 1, wherein as the average speed exceeds the predetermined maximum acceptable speed or minimum unacceptable speed by a greater and greater amount, an increasing number of points are assessed.

16. The method of claim 1, wherein notifying the registered user comprises transmitting a letter, a phone call, a text message, or an electronic mail.

17. The method of claim 1, wherein there is at least one speed limit posted between said first detection device and said second detection device.

18. The method of claim 1, wherein notifying the registered user comprises transmitting a letter from a governmental authority.

19. The method of claim 1, wherein said plurality of detection devices comprises an electronic detection device at each toll booth or roadway entrance along the road.
